(19) United States
(12) Patent Application Publication
(10) Pub. No.: US 2013/0216256 A1
(43) Pub. Date: Aug. 22, 2013

(54) IMAGE FORMING APPARATUS

(71) Applicant: FUJI XEROX CO., LTD., (US)

(72) Inventors: Shuichi NISHIDE, Yokohama-shi (JP); Masahiro SATO, Yokohama-shi (JP); Tetsuji OKAMOTO, Yokohama-shi (JP); Atsushi OGIHARA, Ebina-shi (JP); Koichi WATANABE, Yokohama-shi (JP); Wataru SUZUKI, Ebina-shi (JP); Atsuyuki KITAMURA, Yokohama-shi (JP)

(73) Assignee: FUJI XEROX CO., LTD., Tokyo (JP)

(21) Appl. No.: 13/649,667

(22) Filed: Oct. 11, 2012

(30) Foreign Application Priority Data
Feb. 17, 2012 (JP) 2012-033233

(51) Int. Cl. G03G 15/16

(52) U.S. Cl. 399/101; 399/304

(57) ABSTRACT

An image forming apparatus includes an image carrier; a transfer body; a leading-end holding member that holds a leading-end portion of the recording medium so that the recording medium is wrapped around an outer circumferential surface of the transfer body; a trailing-end holding member that is movable in a circumferential direction of the transfer body, the trailing-end holding member holding a trailing-end portion of the recording medium wrapped around the transfer body such that the trailing-end portion lies along the outer circumferential surface of the transfer body by bringing a holding surface of the trailing-end holding member into contact with the trailing-end portion; and a cleaning portion that contacts the holding surface of the trailing-end holding member, which moves relative to the transfer body, in order to clean the holding surface.

### CROSS-REFERENCE TO RELATED APPLICATIONS

This application is based on and claims priority under 35 USC 119 from Japanese Patent Application No. 2012-033233 filed Feb. 17, 2012.

### BACKGROUND

The present invention relates to image forming apparatuses.

### SUMMARY

An image forming apparatus according to a first aspect of the invention includes an image carrier on whose surface toner images are formed while the image carrier rotates; a transfer body that, while rotating, transports a recording medium to a transfer position, at which the transfer body faces the image carrier; a leading-end holding member that holds a leading-end portion of the recording medium so that the recording medium is wrapped around an outer circumferential surface of the transfer body; a trailing-end holding member that is movable in a circumferential direction of the transfer body, the trailing-end holding member holding a trailing-end portion of the recording medium wrapped around the transfer body such that the trailing-end portion lies along the outer circumferential surface of the transfer body by bringing a holding surface of the trailing-end holding member into contact with the trailing-end portion; and a cleaning portion that contacts the holding surface of the trailing-end holding member, which moves relative to the transfer body, in order to clean the holding surface.

### BRIEF DESCRIPTION OF THE DRAWINGS

Exemplary embodiments of the present invention will be described in detail based on the following figures, wherein:

FIGS. 1A and 1B illustrate states where a holding surface is cleaned by a cleaning roller of an image forming apparatus according to a first exemplary embodiment of the invention when seen from the side;

FIG. 2A illustrates a state where a leading-end holder of the image forming apparatus according to the first exemplary embodiment is in a releasing state when seen from the side and FIG. 2B illustrates a state where the leading-end holder is in a gripping state when seen from the side;

FIG. 3A is a developed view of a transfer drum, the leading-end holder, and a trailing-end holder of the image forming apparatus according to the first exemplary embodiment and FIG. 3B is a side view of the transfer drum, the leading-end holder, and the trailing-end holder;

FIGS. 4A and 4B schematically illustrate a configuration of the trailing-end holder of the image forming apparatus according to the first exemplary embodiment;

FIGS. 5A and 5B schematically illustrate a configuration of the transfer drum and the trailing-end holder of the image forming apparatus according to the first exemplary embodiment;

FIGS. 6A, 6B, 6C, and 6D illustrate a series of states in which a sheet medium is wrapped around the transfer drum of the image forming apparatus according to the first exemplary embodiment;

FIGS. 7A, 7B, 7C, and 7D illustrate a series of states in which the sheet medium that has been wrapped around the transfer drum of the image forming apparatus according to the first exemplary embodiment is separated from the transfer drum;

FIG. 8 is a side view of components, such as the transfer drum and an image carrier, of the image forming apparatus according to the first exemplary embodiment;

FIG. 9 schematically illustrates the image forming apparatus according to the first exemplary embodiment;

FIGS. 10A and 10B illustrate states where the holding surface is cleaned by a cleaning region of an image forming apparatus according to a second exemplary embodiment of the invention when seen from the side; and

FIGS. 11A and 11B illustrate states where the holding surface is cleaned by a cleaning roller of an image forming apparatus according to a third exemplary embodiment of the invention when seen from the side.

### DETAILED DESCRIPTION

### First Exemplary Embodiment

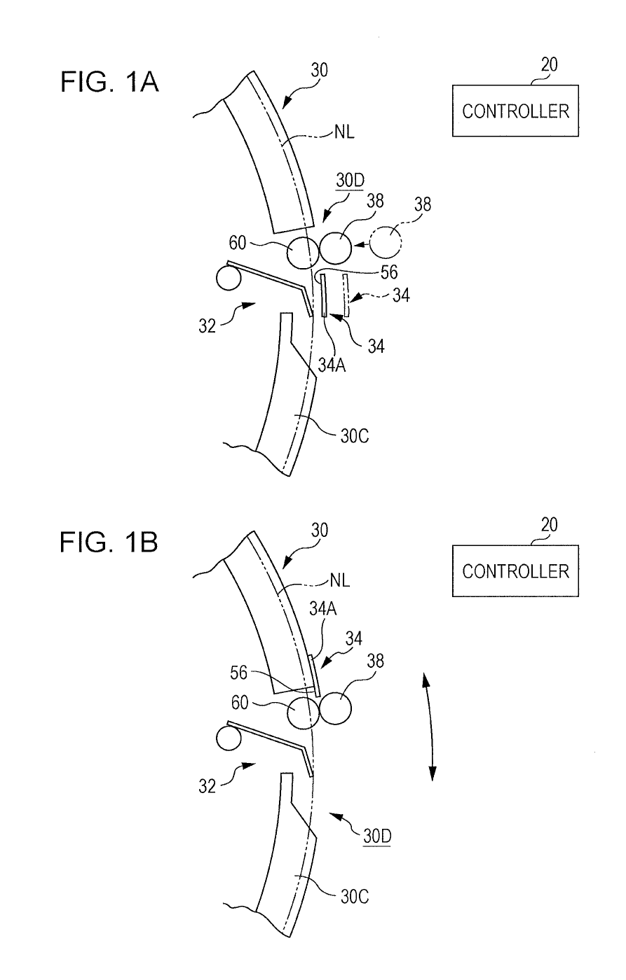

An image forming apparatus 10 according to a first exemplary embodiment of the invention will be described referring to FIGS. 1A to 9.

### Entire Configuration

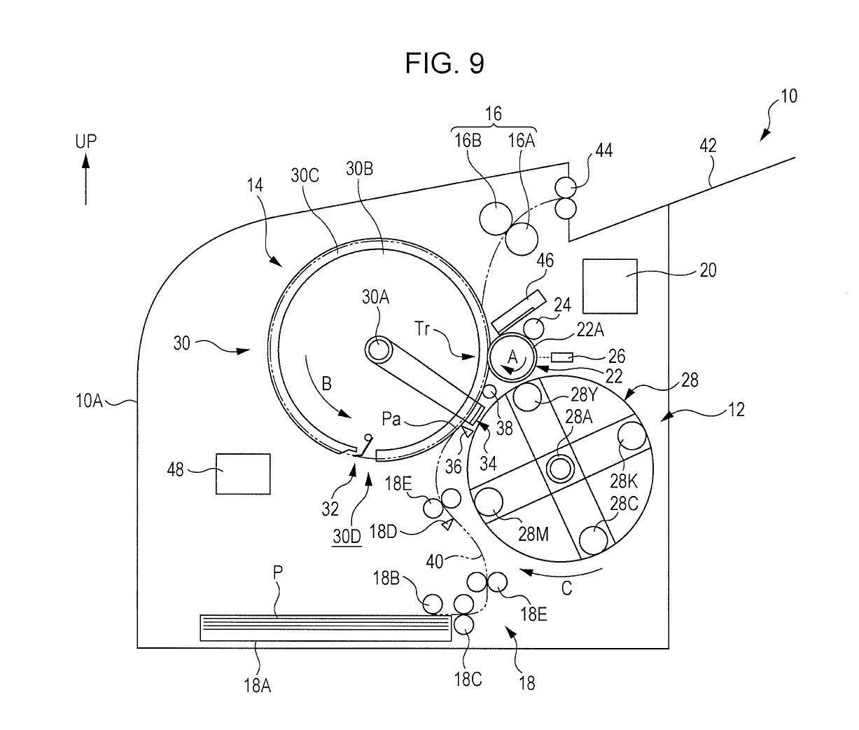

As illustrated in FIG. 9, the image forming apparatus 10 according to the exemplary embodiment of the present invention includes an image forming unit 12, a transfer device 14, a fixing device 16, a sheet feeding unit 18, and a controller 20. The image forming unit 12 forms a toner image. A sheet medium P is a recording medium and is fed to the transfer device 14, and the transfer device 14 transfers the toner image, having been formed by the image forming unit 12, to the sheet medium P that is wrapped around the transfer device 14. The fixing device 16 fixes the toner image, having been formed on the sheet medium P released from the transfer device 14, on the sheet medium P. The sheet feeding unit 18 feeds the sheet medium P to the transfer device 14. The controller 20 controls the entirety of the image forming apparatus 10.

### Image Forming Unit

The image forming unit 12 that forms a toner image will be described first.

The image forming unit 12 includes an image carrier 22, on whose surface toner images are sequentially formed while the image carrier 22 is rotating. The image forming unit 12 also includes a charging device 24, an exposing device 26, a rotary developing device 28, and a cleaning device 46. The charging device 24 charges the surface of the image carrier 22. The exposing device 26 exposes the charged surface of the image carrier 22 to light to form an electrostatic latent image. The rotary developing device 28 develops the electrostatic latent image, having been formed on the surface of the image carrier 22, by using a developer into a toner image. The cleaning device 46 removes remnants remaining on the image carrier 22.

### Image Carrier

The image carrier 22 is disposed so as to rotate in the arrow A direction and includes a negatively charged photosensitive layer 22A on its surface. The charging device 24, the exposing device 26, the rotary developing device 28, and the cleaning device 46 are arranged around the image carrier 22 in this order in the arrow A direction. A driving source (not illustrated) that drives the image carrier 22 to rotate at a peripheral velocity V1 is also provided.

### Charging Device

The charging device 24 is disposed so as to face the image carrier 22. While the charging device 24 is driven to rotate by the rotating image carrier 22, the charging device 24 charges the surface of the image carrier 22.

### Exposing Device

The exposing device 26 irradiates the surface of the image carrier 22 having been charged by the charging device 24 with light to form an electrostatic latent image. In this exemplary embodiment, the exposing device 26 includes, for example, multiple light emitting diodes (LEDs, which are not illustrated).

### Rotary Developing Device

The rotary developing device 28 includes a rotation shaft 28A and developing portions 28Y, 28M, 28C, and 28K for yellow (Y), magenta (M), cyan (C), and black (K) arranged around the rotation shaft 28A. The rotary developing device 28 rotates in the arrow C direction around the rotation shaft 28A.

In the rotary developing device 28, each of the developing portions 28Y, 28M, 28C, and 28K is positioned at a position at which the developing portion faces the image carrier 22. Then, the rotary developing device 28 sequentially develops electrostatic latent images on the image carrier 22 having been formed by the exposing device 26 into toner images of different colors.

These developing portions 28Y, 28M, 28C, and 28K contain developers of corresponding colors.

### Cleaning Device

The cleaning device 46 collects toner remaining on the surface of the image carrier 22 without being transferred to the sheet medium P by the transfer device 14, which will be described below, or other remnants adhering to the surface of the image carrier 22 from the surface. The cleaning device 46 according to the exemplary embodiment is a blade-type cleaner.

### Transfer Device

Now, description will be given on the transfer device 14 around which a sheet medium P is wrapped and that transfers a toner image having been formed by the image forming unit 12 to the wrapped sheet medium P.

The transfer device 14 includes a transfer drum 30, a leading-end holder 32, and a trailing-end holder 34. The transfer drum 30 is taken as an example of a transfer body around which a sheet medium P, to which a toner image on the image carrier 22 is transferred, is wrapped. The leading-end holder 32 is taken as an example of a leading-end holding member that grips a leading-end portion of the sheet medium P wrapped around the transfer drum 30. The trailing-end holder 34 is taken as an example of a trailing-end holding member that restricts the position of a trailing end portion of the sheet medium P.

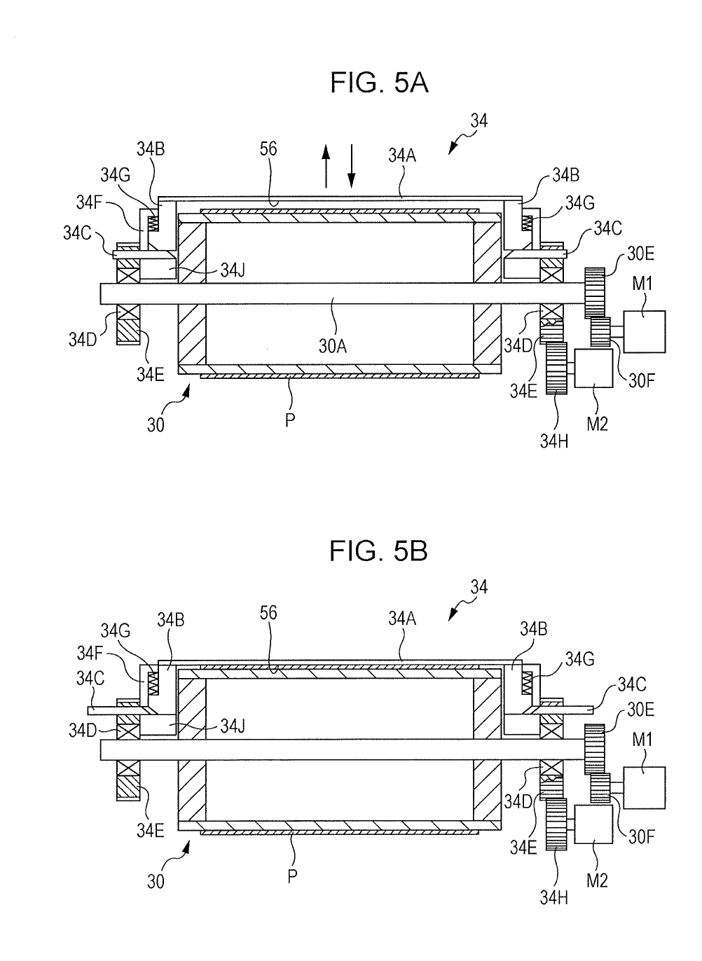

The transfer device 14 also includes a sheet sensor 36 that detects a sheet medium P passing thereby, a driving motor M1 (see FIGS. 5A and 5B) that drives the transfer drum 30 to rotate, a power source 48 that applies a transfer bias, which is a voltage of a polarity opposite to that of the toner, to the transfer drum 30, and a cleaning roller 60. The cleaning roller 60 is an example of a cleaning member that cleans a holding surface 56 of a sheet restricting portion 34. The cleaning roller 60 will be described in detail below.

### Transfer Drum

The transfer drum 30 arranged so as to face the image carrier 22 includes a rotation shaft 30A, a drum-shaped base portion 30B, and an elastically deformable elastic layer 30C that is formed around the outer circumferential surface of the base portion 30B.

The elastic layer 30C, from a leading end to a trailing end of the elastic layer 30C in a direction in which the sheet medium P is transported, lies along the outer circumferential surface of the drum-shaped base portion 30B. A portion of the transfer drum 30, around which even a maximum-size sheet medium P is not wrapped, is a cutout region 30D in which the elastic layer 30C is absent such that a part of the elastic layer 30C in the circumferential direction of the transfer drum 30 is cut out.

The dimensions of the transfer drum 30 and the image carrier 22 and the positional relationships between the transfer drum 30 and the image carrier 22 are determined such that the transfer drum 30 and the image carrier 22 do not contact each other when the cutout region 30D of the transfer drum 30 faces the image carrier 22. A dielectric substance, such as a dielectric sheet, is not attached to the outer circumferential surface of the elastic layer 30C, and thus wrapping of a sheet medium P around the transfer drum 30 does not involve the use of electrostatic attraction.

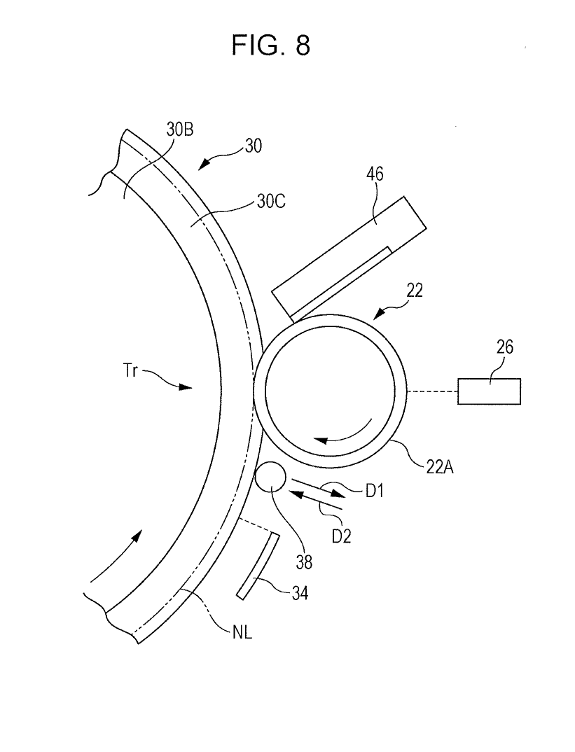

As illustrated in FIG. 8, at a transfer position Tr at which the transfer drum 30 and the image carrier 22 face each other to transfer a toner image to the sheet medium P, the elastic layer 30C of the transfer drum 30 is pressed by the image carrier 22. Here, the elastic layer 30C is pressed by the image carrier 22 down to a compressed circumference NL illustrated in FIG. 8 with the two-dot chain line.

At the transfer position Tr, transporting of the sheet medium P that is nipped by the transfer drum 30 and the image carrier 22 is performed dominantly by using electrostatic attraction of the image carrier 22.

As illustrated in FIGS. 5A and 5B, a gear E is mounted on one end portion of a rotation shaft 30A of the transfer drum 30 and the gear 30E meshes with a gear 30F mounted on an output shaft of the driving motor M1 that drives the transfer drum 30 to rotate. The transfer drum 30 is driven to rotate by the driving force of the driving motor M1 at a peripheral velocity V2, which is lower than the peripheral velocity V1 of the image carrier 22.

### Sheet Sensor

As illustrated in FIG. 9, the sheet sensor 36 is disposed so as to face the outer circumferential surface of the transfer drum 30. The sheet sensor 36 irradiates the sheet medium P, which is transported while being wrapped around the transfer drum 30, with infrared light, and detects the sheet medium P passing thereby using the reflected light.

The sheet sensor 36 is disposed upstream from a stand-by position of the trailing-end holder 34 (the position of the trailing-end holder 34 illustrated in FIG. 9), which will be described below, in the direction in which the sheet medium P is transported, and downstream from a feeding-sheet position Pa, at which a sheet medium P is fed to the transfer drum 30, in the direction in which the sheet medium P is transported.

### Leading-End Holder

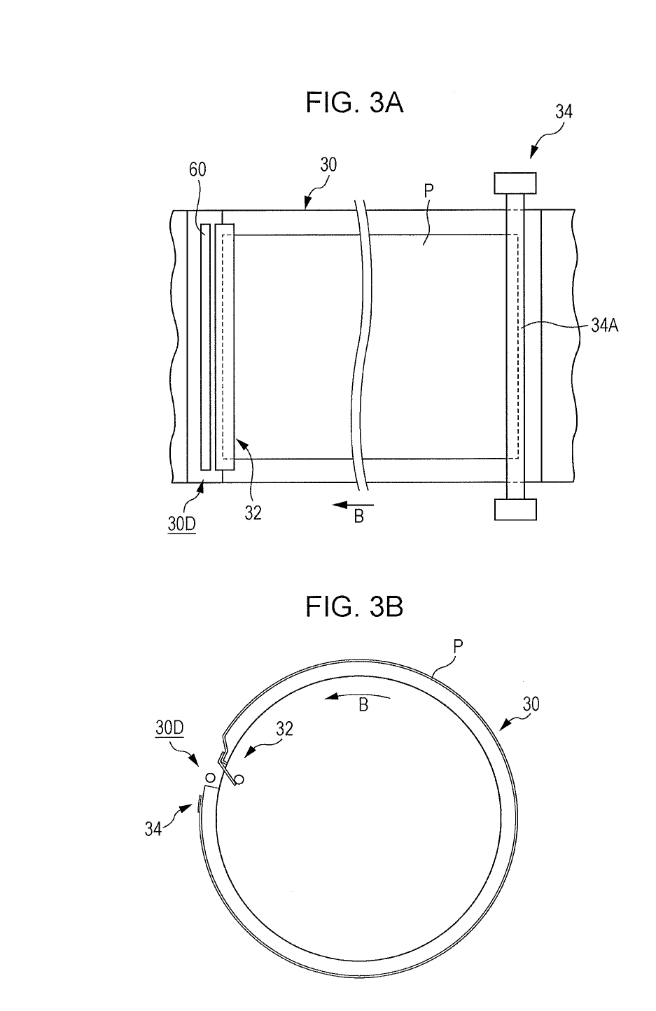

As illustrated in FIGS. 3A and 3B, the leading-end holder 32 that grips the leading-end portion of the sheet medium P wrapped around the transfer drum 30 is attached to the transfer drum 30, and is disposed in the cutout region 30D. FIG. 3A is a developed view in which the outer circumferential surface of the transfer drum 30 is developed.

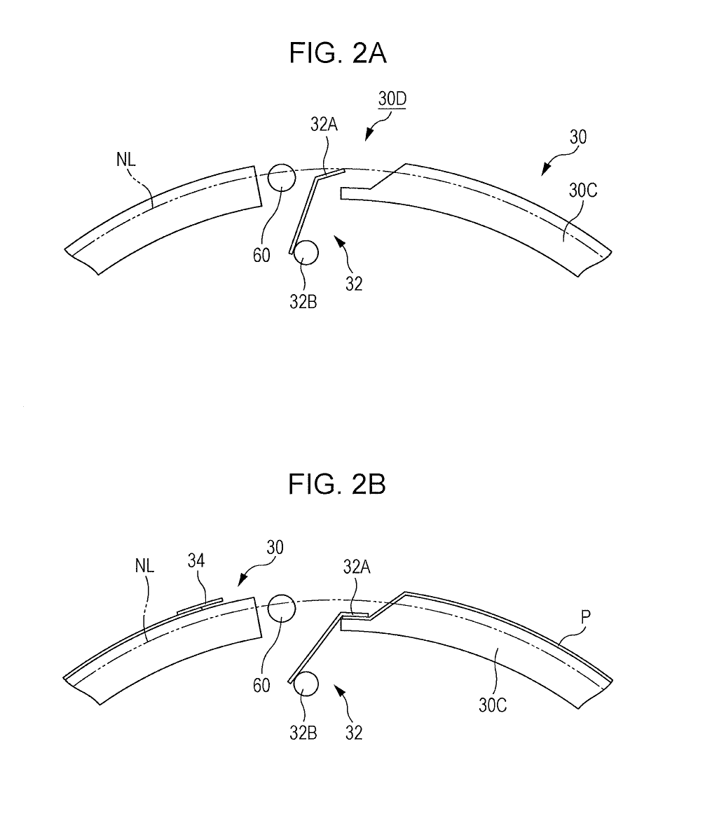

As illustrated in FIGS. 2A and 2B, the leading-end holder 32 includes a pressing plate 32A and a shaft member 32B. The pressing plate 32A presses the leading-end portion of the sheet medium P against the elastic layer 30C. The shaft member 32B rotates the pressing plate 32A such that the pressing plate 32A grips or releases the leading-end portion of the sheet medium P.

The pressing plate 32A extends in a direction of a rotation axis of the transfer drum 30 (hereinafter also simply referred to as a “drum axis direction”). For example, the pressing plate 32A is formed by bending a stainless steel plate, and has a single bent portion when viewed in the drum axis direction.

An axis direction of the shaft member 32B is parallel to the drum axis direction. The shaft member 32B, which is cylindrical, is secured to a first end portion of the pressing plate 32A. Accordingly, when the shaft member 32B is rotated, the leading-end holder 32 moves so as to switch between a gripping state (see FIG. 2B), in which a second end portion of the pressing plate 32A grips the leading-end portion of the sheet medium P, and a releasing state (see FIG. 2A), in which the second end portion releases the leading-end portion of the sheet medium P.

As illustrated in FIGS. 2A and 2B, a locus of the leading-end holder 32 that moves so as to switch between the gripping state and the releasing state is formed on the inner side of the compressed circumference NL, and thus the leading-end holder 32 does not contact the image carrier 22. In other words, the leading-end holder 32 is located outside a region within which the image carrier 22 compresses the elastic layer 30C, and thus when the leading-end holder 32 has been moved to the transfer position Tr, the leading-end holder 32 is separated from the image carrier 22.

A film-formed restricting member, which is not illustrated, is attached to the pressing plate 32A. The film-formed restricting member restricts a leading-end side of the sheet medium P whose leading-end portion is gripped by the leading-end holder 32 such that the leading-end side lies along the elastic layer 30C.

### Trailing-End Holder

As illustrated in FIGS. 3A and 3B, the trailing-end holder 34 is stretched across the transfer drum 30 in the drum axis direction, and rotates around the rotation shaft 30A independently of the transfer drum 30.

As illustrated in FIGS. 5A and 5B, the trailing-end holder 34 includes a sheet restricting portion 34A extending in the drum axis direction, and holding portions 34B that hold both end portions of the sheet restricting portion 34A. The sheet restricting portion 34A stops the trailing-end portion of the sheet medium P from moving.

The sheet restricting portion 34A is made of a film-formed resin material and is elastically deformable. Examples of the resin material include polyethylene terephthalate (PET), polyimide, and fluorocarbon resins.

The holding portions 34B extend in the radial direction of the transfer drum 30 (also simply referred to as a “drum radius direction”, below). The trailing-end holder 34 also includes wedge-shaped shifting members 34C, whose movement in the drum axis direction causes the sheet restricting portion 34A to move in the drum radius direction via the holding portions 34B.

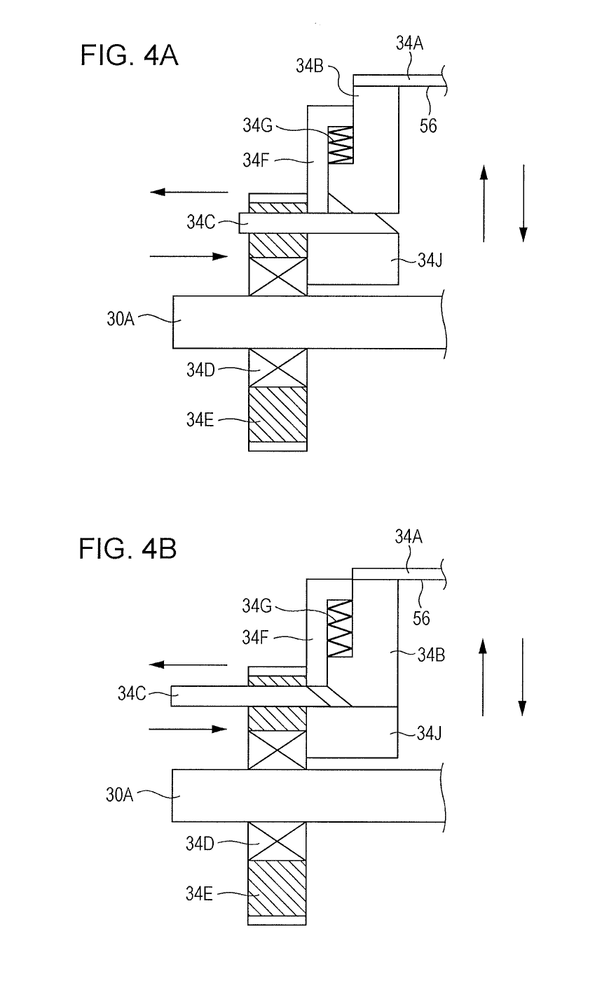

As illustrated in FIGS. 4A and 4B, gears 34E are mounted on the rotation shaft 30A via bearings 34D, and supporting portions 34F extending in the drum radius direction are disposed at the gears 34E. Each holding portion 34B is disposed so as to be movable relative to a corresponding one of the supporting portions 34F in the drum radius direction. A spring member 34G is interposed between each holding portion 34B and a corresponding supporting portion 34F, and the spring member 34G urges the holding portion 34B in a radially inward direction. The trailing-end holder 34 also includes stopper portions 34J that restrict the positions of the holding portions 34B when the holding portions 34B having been urged by the spring members 34G in the radially inward direction abut against the stopper portions 34J.

In this configuration, when the controller 20 controls a solenoid, which is not illustrated, to move the wedge-shaped shifting members 34C in the drum axis direction into spaces between the holding portions 34B and the stopper portions 34J, the holding portions 34B are moved in a radially outward direction. With this operation, the sheet restricting portion 34A switches to the releasing state, in which the sheet restricting portion 34A becomes separated from the elastic layer 30C to release the trailing-end portion of the sheet medium P (see FIGS. 4A and 5A).

On the other hand, when the controller 20 controls a solenoid, which is not illustrated, to move the wedge-shaped shifting members 34C in the drum axis direction and pull out the wedge-shaped shifting members 34C from the spaces between the holding portions 34B and the stopper portions 34J, the holding portions 34B are moved in a radially inward direction. With this operation, the holding surface 56 of the sheet restricting portion 34A facing the transfer drum 30 switches to the restricting state (see FIGS. 4B and 5B) in which the sheet restricting portion 34A brings the trailing-end portion of the sheet medium P into contact with the elastic layer 30C such that the trailing-end portion lies along the elastic layer 30C.

As illustrated in FIGS. 5A and 5B, a driving motor M2 that drives the trailing-end holder 34 to rotate around the rotation shaft 30A is provided, and a gear 34H that is mounted on an output shaft of the driving motor M2 meshes with one of the gears 34E.

As described above, since the trailing-end holder 34 is disposed as a body that is separate from the transfer drum 30, the position of the trailing-end holder 34 relative to the transfer drum 30 is changeable.

When the leading-end holder 32 grips the leading-end portion of the sheet medium P, the leading-end holder 32 does not allow the sheet medium P to move in the transporting direction and stops the sheet medium P from moving away from the transfer drum 30. On the other hand, when the trailing-end holder 34 restricts the trailing-end portion of the sheet medium P, the trailing-end holder 34 allows the sheet medium P to move in the transporting direction but stops the sheet medium P from moving away from the transfer drum 30.

### Fixing Device

The fixing device 16 that fixes a toner image formed on a sheet medium P on the sheet medium P will be described now.

As illustrated in FIG. 9, the fixing device 16 includes a heating roller 16A and a pressurizing roller 16B. The heating roller 16A includes a heating source (not illustrated) and a rotary force is transmitted to the heating roller 16A. The pressurizing roller 16B is in contact with the heating roller 16A with pressure.

When a sheet medium P holding a toner image is nipped between and transported by the heating roller 16A and the pressurizing roller 16B, the toner image is melted and pressurized and is thus fixed on the sheet medium P.

Discharging rollers 44 are disposed downstream from the fixing device 16 in the direction in which the sheet medium P is transported. The discharging rollers 44 discharge the sheet medium P, having a toner image fixed thereon, to a discharge portion 42 formed on an upper surface of an apparatus body 10A.

### Sheet Feeding Unit

Now, the sheet feeding unit 18 that feeds a sheet medium P to the transfer device 14 will be described.

The sheet feeding unit 18 is disposed at a lower portion in the apparatus body 10A of the image forming apparatus 10 and includes a sheet containing member 18A, a pick-up roller 18B, separation rollers 18C, and a leading-end sensor 18D. The sheet containing member 18A contains sheet media P. The pick-up roller 18B picks up the sheet media P from the sheet containing member 18A. The separation rollers 18C separate closely-attached sheet media P from each other. The leading-end sensor 18D detects the leading-end portion of a sheet medium P passing thereby.

The sheet feeding unit 18 also includes multiple transporting rollers 18E. Each sheet medium P is transported by the transporting rollers 18E along a transport path 40.

In this manner, each sheet medium P is transported along the transport path 40 from the sheet containing member 18A to the feeding-sheet position Pa, which is positioned upstream from the transfer position Tr in the direction of rotation of the transfer drum 30.

### Operations of Entire Configuration

Now, operations of the entire configuration will be described.

Firstly, color image data that has been formed by a personal computer or the like, which is not illustrated, is input to an image signal processor (not illustrated) as red (R), green (G), and blue (B) data, for example, and is then subjected to image processing. The image data that has been subjected to image processing is converted into four-color gradation data for yellow (Y), magenta (M), cyan (C), and black (K), which is output to the exposing device 26, so that an image forming operation is started.

With the start of the image forming operation, the image carrier 22 and the transfer drum 30 start rotating together as illustrated in FIG. 9. Here, the peripheral velocity V1 of the image carrier 22 is higher than the peripheral velocity V2 of the transfer drum 30. For example, the peripheral velocity V1 of the image carrier 22 is approximately 0.5% to 1% higher than the peripheral velocity V2 of the transfer drum 30.

At this time, the leading-end holder 32 and the trailing-end holder 34 are in the releasing state.

While the leading-end holder 32 rotates together with the transfer drum 30, the trailing-end holder 34 remains stationary at the stand-by position without rotating together with the transfer drum 30 while being in the releasing state.

After the photosensitive layer 22A of the rotating image carrier 22 is charged by the charging device 24, the exposing device 26 irradiates the image carrier 22 with light so that an electrostatic latent image for a first color (yellow, for example) based on the image information is formed on the image carrier 22.

Meanwhile, the rotary developing device 28 rotates so that a developing portion containing a toner of the color corresponding to the electrostatic latent image to be formed on the image carrier 22 (the yellow developing portion 28Y, if the corresponding color is yellow) is positioned at a position opposite the image carrier 22.

Thereafter, the developing portion 28Y develops the electrostatic latent image on the image carrier 22 to form a toner image on the image carrier 22. This toner image is transported toward the transfer position Tr, at which the toner image faces the transfer drum 30, with the rotation of the image carrier 22.

With the start of the image forming operation, feeding of a sheet medium P is also started. Specifically, sheet media P that are picked up from the sheet containing member 18A by the pick-up roller 18B are separated by the separation rollers 18C. The separated sheet media P are forwarded to the transport path 40 by the transporting rollers 18E. The leading-end sensor 18D then detects the leading-end portion of each sheet medium P passing thereby and transmits a detection signal to the controller 20.

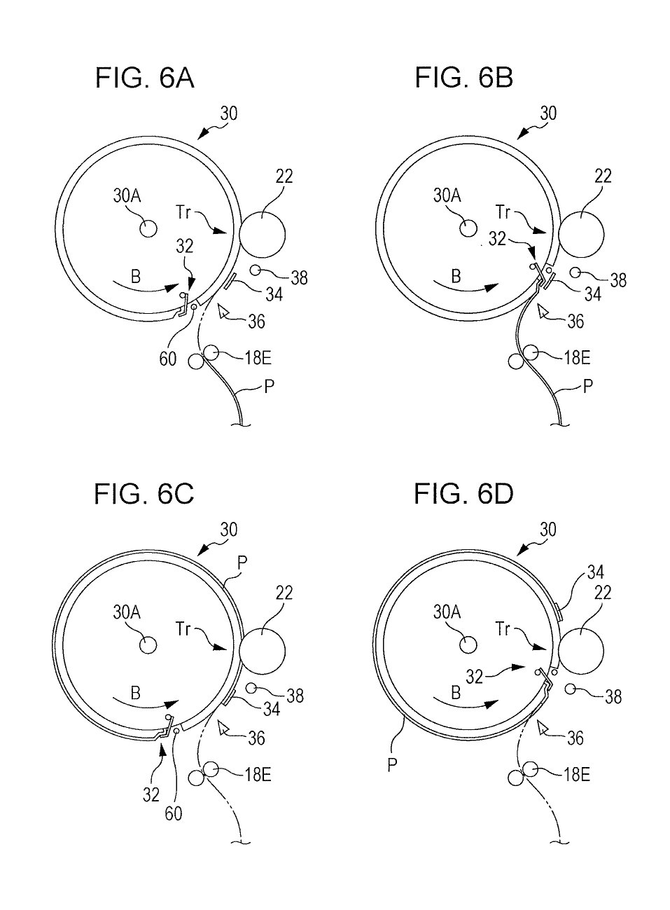

The controller 20 that has received the detection signal controls transportation of the sheet medium P on the basis of the detection signal such that the sheet medium P arrives at the feeding-sheet position Pa at the same time as when the leading-end holder 32 arrives at the feeding-sheet position Pa (see FIG. 6A).

Here, at the time of feeding the sheet medium P, information on the size of the sheet medium P that has been detected by a sheet-size sensor (not illustrated) is transmitted to the controller 20.

As illustrated in FIG. 6B, the leading-end holder 32 that has been in the releasing state switches to the gripping state upon arrival of the leading-end portion of the sheet medium P at the feeding-sheet position Pa. The leading-end portion of the sheet medium P is thus gripped by the leading-end holder 32.

The leading-end holder 32 gripping the sheet medium P then passes a position opposite the stationary trailing-end holder 34. The leading-end holder 32 having passed the trailing-end holder 34 then moves toward the transfer position Tr while gripping the sheet medium P.

The sheet medium P that has passed the transfer position Tr while being gripped by the leading-end holder 32 is consequently wrapped around the transfer drum 30 while being gripped by the leading-end holder 32, as illustrated in FIG. 6C.

The toner image of the first color (yellow, for example) formed on the image carrier 22 is transferred to the sheet medium P on the transfer drum 30 at the transfer position Tr at which the image carrier 22 and the transfer drum 30 face each other. Part of toner remaining on the image carrier 22 after the transfer is collected from the image carrier 22 by the cleaning device 46 (see FIG. 8).

Thereafter, the sheet sensor 36 detects the trailing end portion of the sheet medium P passing thereby. Upon receipt of a signal from the sheet sensor 36, the controller 20 sends an instruction to the trailing-end holder 34.

Upon receipt of the instruction, the trailing-end holder 34 switches from the releasing state to the restricting state to restrict the trailing end portion of the sheet medium P. The trailing-end holder 34 that has switched to the restricting state starts rotating together with the transfer drum 30. In other words, the sheet restricting member 34A of the trailing-end holder 34 moves at the same velocity as the peripheral velocity V2 of the transfer drum 30.

As illustrated in FIG. 6D, the trailing-end holder 34 rotating together with the transfer drum 30 passes the transfer position Tr while restricting the trailing end portion of the sheet medium P.

Likewise, forming and developing of latent images for second and subsequent colors (magenta and cyan, for example), which precede a final color (black, for example), and transferring of toner images corresponding to the latent images is repeated in accordance with the above-described procedure.

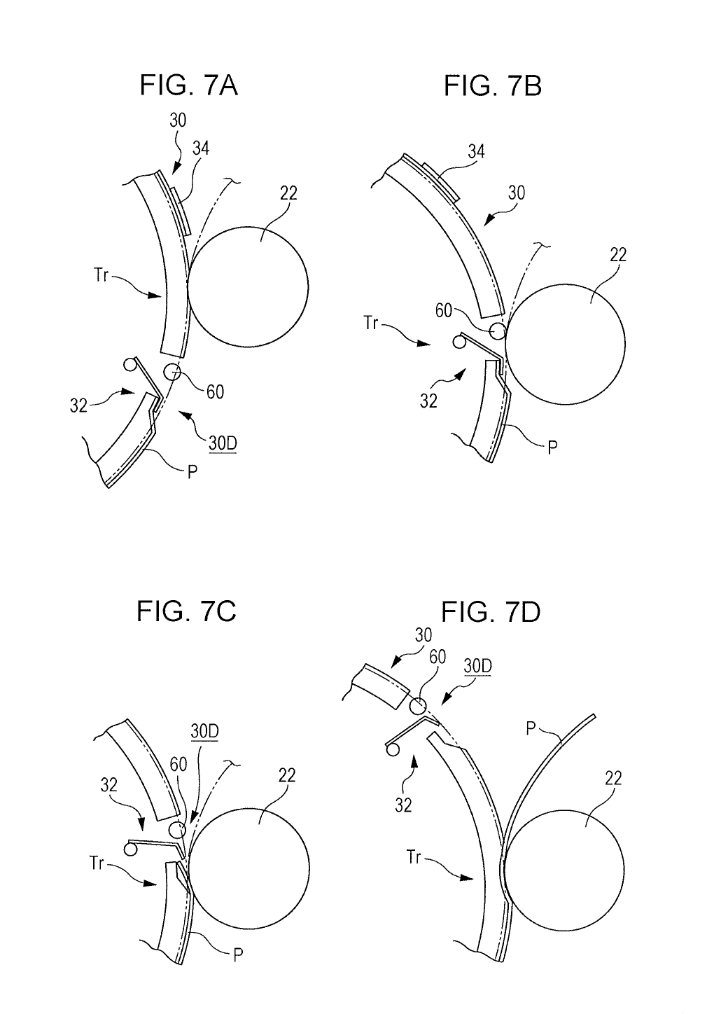

As illustrated in FIGS. 7A to 7C, in the case of transferring a toner image of a final color (black, for example), the leading-end holder 32 switches from the gripping state to the releasing state at the transfer position Tr, unlike in the case of transferring a toner image of a color that precedes the final color.

As illustrated in FIGS. 7C and 7D, when the leading-end holder 32 releases the leading-end portion of the sheet medium P on which multiple toner images are formed, a leading-end side of the sheet medium P becomes separated from the transfer drum 30 due to having been nipped by the elastic layer 30C and the image carrier 22.

The sheet medium P whose leading end side is separated from the transfer drum 30 is transported toward the fixing device 16 illustrated in FIG. 9.

As the sheet medium P is transported further, the trailing-end holder 34 restricting the trailing end portion of the sheet medium P arrives at the stand-by position. At the stand-by position, the trailing-end holder 34 switches from the restricting state to the releasing state to release the trailing end portion of the sheet medium P. The trailing-end holder 34 that has switched to the releasing state stops at the stand-by position.

The toner image on the sheet medium P having been transported to the fixing device 16 is fixed on the sheet medium P by the fixing device 16. As the sheet medium P is transported further, the sheet medium P becomes separated from the transfer drum 30. The sheet medium P is finally discharged to the discharge portion 42 by the discharging rollers 44.

### Configuration of Related Portions

Now, the cleaning roller 60 and other components will be described.

As illustrated in FIGS. 2A and 2B, the cleaning roller 60 is disposed in the cutout region 30D and extends in the drum axis direction. The cleaning roller 60 rotates around the rotation shaft 30A together with the transfer drum 30 so as to accompany the rotation of the transfer drum 30. When seen in the drum axis direction, part of the cleaning roller 60 is disposed beyond the compressed circumference NL. In other words, part of the cleaning roller 60 is disposed in an area of the elastic layer 30C that is compressed by the image carrier 22. The part of the cleaning roller 60 is thus pressed by the image carrier 22 at the transfer position Tr and deformed elastically.

How the controller 20 drives other components to clean the holding surface 56 will be described below together with description of operations of related components.

### Operations of Related Components

Now, a cleaning operation for cleaning the holding surface 56 will be described.

The image forming apparatus 10 does not perform the cleaning operation while performing the image forming operation. After the image forming apparatus 10 finishes the image forming operation and the trailing-end holder 34 switches to the releasing state at the stand-by position, the cleaning operation is started.

As illustrated in FIG. 1A, when the cleaning operation is started, the controller 20 rotates the transfer drum 30 so as to cause the cleaning roller 60 to face the pressing roller 38 that is separated from the transfer drum 30. The controller 20 also moves the pressing roller 38 so that the outer circumferential surface of the pressing roller 38 is pressed against the outer circumferential surface of the cleaning roller 60 (see the pressing roller 38 drawn by the solid line in FIG. 1A). Consequently, a nip portion is defined by the cleaning roller 60 and the pressing roller 38.

The controller 20 also switches the trailing-end holder 34 that has been in the releasing state at the stand-by position (see the trailing-end holder 34 drawn by the two-dot chain line in FIG. 1A) to the restricting state (see the trailing-end holder 34 drawn by the solid line in FIG. 1A).

As illustrated in FIG. 1B, the controller 20 then causes the trailing-end holder 34 to reciprocate such that the sheet restricting portion 34A passes the nip portion multiple times while the transfer drum 30 remains stationary. Consequently, remnants that have adhered to the holding surface 56 are removed by the cleaning roller 60 and the holding surface 56 is accordingly cleaned. One example of causes of remnants (toner or the like) adhering to the holding surface 56 is that a sheet medium P carrying a toner image that has not yet been fixed to the sheet medium P is jammed between the transfer drum 30 and the image carrier 22.

As described above, the pressing roller 38 presses the holding surface 56 of the sheet restricting portion 34A, which moves relative to the transfer drum 30, against the cleaning roller 60 to cause the cleaning roller 60 to clean the holding surface 56.

After the sheet restricting portion 34A passes the nip portion multiple times, the controller 20 switches the trailing-end holder 34 to the releasing state at the stand-by position and separates the pressing roller 38 from the transfer drum 30. With these operations, the cleaning operation is complete.

Cleaning of the holding surface 56 in the above manner keeps the trailing-end portion of a subsequent sheet medium P clean from dirt when the holding surface 56 restricts the trailing-end portion of the sheet medium P.

Furthermore, the holding surface 56 is effectively cleaned by the pressing roller 38 pressing the holding surface 56 against the cleaning roller 60.

Moreover, the shape of the cleaning roller 60 may be more flexibly determined since the cleaning roller 60 is disposed in the cutout region 30D.

### Second Exemplary Embodiment

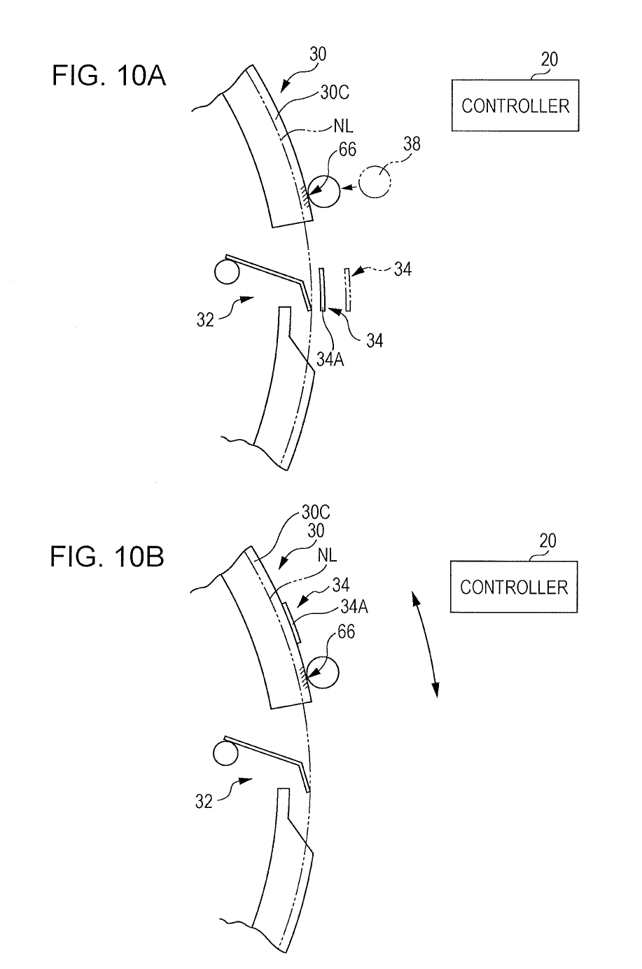

Referring now to FIGS. 10A and 10B, an image forming apparatus 10 according to a second exemplary embodiment of the invention will be described. Components that are the same as those in the first exemplary embodiment will be denoted by the same reference symbols and description thereof is not provided.

As illustrated in FIGS. 10A and 10B, the image forming apparatus 10 according to the second exemplary embodiment includes no cleaning roller but a cleaning region 66 (the shaded region in FIGS. 10A and 10B), which is an example of a cleaner. The cleaning region 66 is disposed in a region that constitutes part of the elastic layer 30C on a trailing-end side of the elastic layer 30C in the direction in which the sheet medium P is transported and no sheet medium P is wrapped around the region. In other words, the cleaning region 66 is disposed at a position at which the cleaning region 66 does not come into contact with the sheet medium P even when the elastic layer 30C supports a sheet medium P of a maximum size.

When the cleaning operation is started, the controller 20 rotates the transfer drum 30 so as to cause the cleaning region 66 to face the pressing roller 38 that is separated from the transfer drum 30, as illustrated in FIG. 10A. The controller 20 also moves the pressing roller 38 so that the outer circumferential surface of the pressing roller 38 is pressed against the outer circumferential surface of the cleaning region 66 (see the pressing roller 38 drawn by the solid line in FIG. 10A). Consequently, a nip portion is defined by the cleaning region 66 and the pressing roller 38.

The controller 20 also switches the trailing-end holder 34 that has been in the releasing state (see the trailing-end holder 34 drawn by the two-dot chain line in FIG. 10A) at the stand-by position to the restricting state (see the trailing-end holder 34 drawn by the solid line in FIG. 10A).

Subsequently, the controller 20 causes the trailing-end holder 34 to reciprocate such that the sheet restricting portion 34A passes the nip portion multiple times while the transfer drum 30 remains stationary, as illustrated in FIG. 10B. Consequently, remnants that have adhered to the holding surface 56 are removed by the cleaning region 66 and the holding surface 56 is accordingly cleaned.

By forming part of the elastic layer 30C into the cleaning region 66, the need to separately provide a cleaning portion is eliminated.

Other operations are the same as those in the first exemplary embodiment.

### Third Exemplary Embodiment

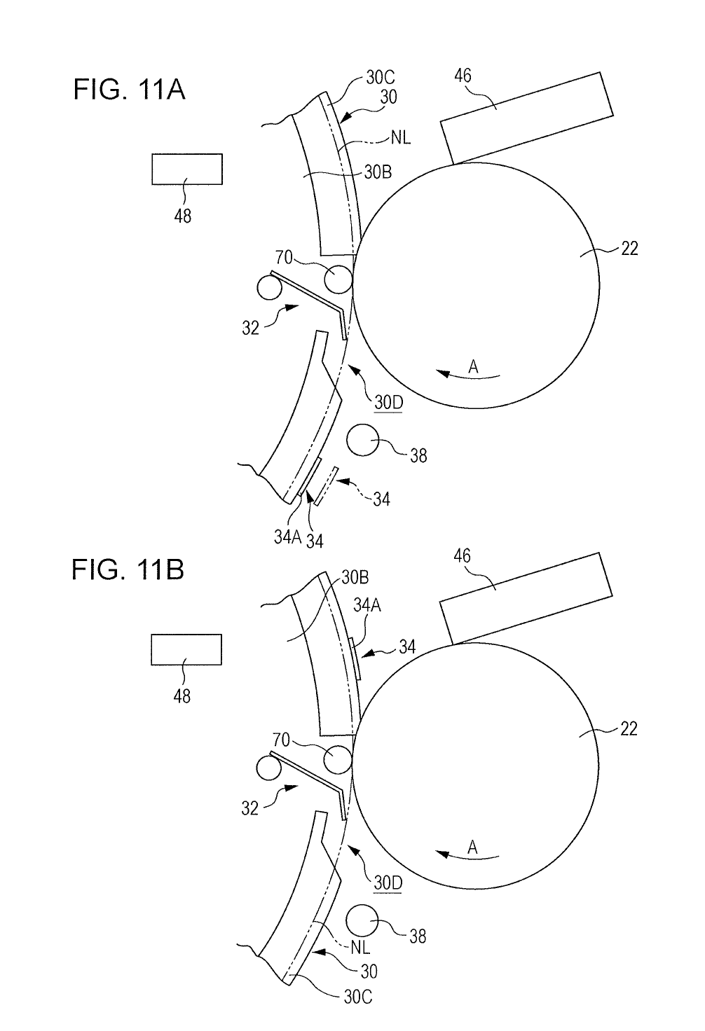

Referring now to FIGS. 11A and 11B, an image forming apparatus 10 according to a third exemplary embodiment of the invention will be described. Components that are the same as those in the first exemplary embodiment will be denoted by the same reference symbols and description thereof is not provided.

As illustrated in FIGS. 11A and 11B, a cleaning roller 70 according to the third exemplary embodiment is disposed such that an outer circumferential surface of the cleaning roller 70 meets the compressed circumference NL from the inner side in the radial direction.

The controller 20 controls the power source 48 such that the power source 48 applies a transfer bias, which is a voltage of a polarity opposite to that of the toner, to the base portion 30B, or applies a non-transfer bias, which is a voltage of the same polarity as that of the toner, to the cleaning roller 70.

When the cleaning operation is started, the controller 20 rotates the transfer drum 30 so as to cause the cleaning roller 70 to face the image carrier 22 as illustrated in FIG. 11A. Consequently, a nip portion is defined by the cleaning roller 70 and the image carrier 22.

The controller 20 also switches the trailing-end holder 34 that has been in the releasing state (the trailing-end holder 34 drawn by the two-dot chain line in FIG. 11A) at the stand-by position to the restricting state (the trailing-end holder 34 drawn by the solid line in FIG. 11A).

As illustrated in FIG. 11B, the controller 20 then causes the trailing-end holder 34 to reciprocate such that the sheet restricting portion 34A passes the nip portion multiple times while the transfer drum 30 remains stationary. Consequently, remnants such as toner that have adhered to the holding surface 56 are removed by the cleaning roller 70 and the holding surface 56 is accordingly cleaned.

After the sheet restricting portion 34A passes the nip portion multiple times, the controller 20 moves the trailing-end holder 34 to the stand-by position to switch the trailing-end holder 34 to the releasing state. Here, the controller 30 also rotates the image carrier 22 in the arrow A direction.

Subsequently, the controller 20 controls the power source 48 so that the power source 48 applies a non-transfer bias to the cleaning roller 70. With this operation, remnants such as toner that have adhered to the cleaning roller 70 transfer to the surface of the image carrier 22.

Thereafter, the remnants that have transferred to the surface of the image carrier 22 are collected by the cleaning device 46 from the image carrier 22.

As described above, in the third exemplary embodiment, the power source 48 is used as an example of a transfer unit that transfers remnants that have adhered to the cleaning roller 70 to the image carrier 22. In addition, the image carrier 22 is used as an example of a pressing member that presses the holding surface 56 against the cleaning roller 70 to cause the cleaning roller 70 to clean the holding surface 56.

As described above, remnants that have adhered to the cleaning roller 70 are collected by the cleaning device 46 via the image carrier 22, thereby maintaining the performance of the cleaning roller 70 to clean the holding surface 56.

Moreover, the use of the image carrier 22 as a pressing member leads to a reduction in the number of components. Other operations are the same as those in the first exemplary embodiment.

Although the present invention has been described in detail on the basis of specific exemplary embodiments, it is obvious to those skilled in the art that the present invention is not limited to the exemplary embodiments and that various other exemplary embodiments may be made within the scope of the invention. For example, in the exemplary embodiments, it is described that the cleaning operation is started after the image forming operation is finished. However, the timing of the cleaning operation is not particularly limited to the above, and the cleaning operation may be started with an instruction of a user, for example.

In the first and second exemplary embodiments, the pressing roller 38 is used to press the holding surface 56 against the cleaning roller 60 or the cleaning region 66. However, the holding surface 56 may be cleaned without using the pressing roller 38.

In the exemplary embodiments, the sheet restricting portion 34A is caused to pass the nip portion multiple times, but the sheet restricting portion 34A may be caused to pass the nip portion once.

Although not particularly described in the exemplary embodiments, the second exemplary embodiment and the third exemplary embodiment may be combined with each other.

The foregoing description of the exemplary embodiments of the present invention has been provided for the purposes of illustration and description. The present invention is not limited to these exemplary embodiments. Modification, deletion, or addition is allowed in the present invention as long as it falls within the technical idea of the present invention that is understandable by those skilled in the art through the scope of claims, detailed description, and description of the drawings.

What is claimed is:

1. An image forming apparatus comprising:
an image carrier on whose surface toner images are formed while the image carrier rotates;
a transfer body that, while rotating, transports a recording medium to a transfer position, at which the transfer body faces the image carrier;
a leading-end holding member that holds a leading-end portion of the recording medium so that the recording medium is wrapped around an outer circumferential surface of the transfer body;
a trailing-end holding member that is movable in a circumferential direction of the transfer body, the trailing-end holding member holding a trailing-end portion of the recording medium wrapped around the transfer body such that the trailing-end portion lies along the outer circumferential surface of the transfer body by bringing a holding surface of the trailing-end holding member into contact with the trailing-end portion; and
a cleaning portion that contacts the holding surface of the trailing-end holding member, which moves relative to the transfer body, in order to clean the holding surface.

2. The image forming apparatus according to claim 1, wherein the cleaning portion is disposed in an exposed region of the transfer body, which is exposed through the recording medium when the recording medium is wrapped around the outer circumferential surface of the transfer body.

3. The image forming apparatus according to claim 2,
wherein the transfer body has an elastic layer at an outer circumference thereof, a portion of the elastic layer being cut out in the circumferential direction of the transfer body, and
wherein the cleaning portion is disposed in a cutout region, which is the portion of the elastic layer that is cut out.

4. The image forming apparatus according to claim 2,
wherein the transfer body has an elastic layer at an outer circumference thereof, the elastic layer having a cut out portion at a first area of the transfer body, the elastic layer supporting the recording medium at a second area of the elastic layer, and
wherein the cleaning portion is disposed in the exposed region at a third area of the elastic layer.

5. The image forming apparatus according to claim 1, wherein the holding surface is pressed against the cleaning member by a pressing member.

6. The image forming apparatus according to claim 2, wherein the holding surface is pressed against the cleaning member by a pressing member.

7. The image forming apparatus according to claim 3, wherein the holding surface is pressed against the cleaning member by a pressing member.

8. The image forming apparatus according to claim 4, wherein the holding surface is pressed against the cleaning member by a pressing member.

9. The image forming apparatus according to claim 5, wherein the image carrier is used as the pressing member.

10. The image forming apparatus according to claim 6, wherein the image carrier is used as the pressing member.

11. The image forming apparatus according to claim 7, wherein the image carrier is used as the pressing member.

12. The image forming apparatus according to claim 8, wherein the image carrier is used as the pressing member.

13. The image forming apparatus according to claim 9, further comprising:
a transfer unit that transfers a remnant that has adhered to the cleaning member to the image carrier; and
a collecting device that collects the remnant that has been transferred to the image carrier from the image carrier.

14. The image forming apparatus according to claim 10, further comprising:
a transfer unit that transfers a remnant that has adhered to the cleaning member to the image carrier; and
a collecting device that collects the remnant that has been transferred to the image carrier from the image carrier.

15. The image forming apparatus according to claim 11, further comprising:
a transfer unit that transfers a remnant that has adhered to the cleaning member to the image carrier; and
a collecting device that collects the remnant that has been transferred to the image carrier from the image carrier.

16. The image forming apparatus according to claim 12, further comprising:
a transfer unit that transfers a remnant that has adhered to the cleaning member to the image carrier; and
a collecting device that collects the remnant that has been transferred to the image carrier from the image carrier.
